(19) United States
(12) Patent Application Publication
(10) Pub. No.: US 2020/0217674 A1
(43) Pub. Date: Jul. 9, 2020

(54) Meeting Coordinator Minimizing Joint Driving Time

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/585,392

(22) Filed: Sep. 27, 2019

Related U.S. Application Data
(60) Provisional application No. 62/788,938, filed on Jan. 6, 2019.

(51) Int. Cl. G01C 21/34; G06Q 10/10

(52) U.S. Cl. CPC G01C 21/3438; G06Q 10/1095; G01C 21/3461; G01C 21/3484

(57) ABSTRACT

The present invention provides a mechanism that not only creates the quickest route for a group of people to a common location, but also selects the location for which the individual's longest driving time (between all parties) will be the shortest overall. This system is designed to automatically optimize meeting locations for a group of geographically separated members comprising a communication mechanism for transmitting the location of each member to a processor, a processor including a database containing the members of the meeting, a road network, and a list of possible locations to meet, as well as an optimization algorithm that computes the location of the meeting to accommodate one or more variety of utility functions (minimum overall time, least fuel, least wear and tear, minimum tolls/fares as well as minimum time including waiting time at the meeting location.

### CROSS REFERENCE TO RELATED PATENT APPLICATIONS

This application claims priority from U.S. Patent Application Ser. 62/788,938, entitled “Meeting Coordinator Joint Driving Time”, filed on 6 Jan. 2019. The benefit under 35 USC § 119(e) of the United States provisional application is hereby claimed, and the aforementioned application is hereby incorporated herein by reference.

### STATEMENT REGARDING FEDERAL SPONSORSHIP

No part of this invention was a result of any federally sponsored research.

### TECHNICAL FIELD OF THE INVENTION

The present invention relates in general to autonomous systems, and, more specifically, to a meeting coordinator minimizing joint driving time.

### COPYRIGHT AND TRADEMARK NOTICE

A portion of the disclosure of this patent application may contain material that is subject to copyright protection. The owner has no objection to the facsimilereproduction by anyone of the patent document or the patent disclosure, as it appears in the Patent and Trademark Office patent file or records, but otherwise reserves all copyrightswhatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

As cities become more populated, traffic becomes an increasing nuisance affecting every pedestrian, driver, and bystander. Since population increases generally indicate an increase in the number of vehicles, traffic is likely to continue being a challenge for generations, wasting time, energy, and polluting the environment. The proposed invention is a system being that makes efficient use of our transportation infrastructure, providing significant advantages in these areas.

Many tools are already provided that guide a driver while avoiding traffic, so that a vehicle can arrive at their destination as quickly as possible. The invention being taught is different than these tools, in the sense that the optimizer can choose between multiple destinations for a group of people attempting to meet. I would like to meet a friend at XYZ coffee shop and ZYZ has multiple locations (A, B, and C). If I decide to meet my friend at A, it will take some time for both to arrive at A. If we choose B, it will also take some time for both of use to arrive at B, most likely a different amount of time. Likewise, it would take a different amount of time to meet at C. In other words, given the road infrastructure and the current (or predicted) traffic, selecting one of these meeting locations will have both parties met together faster, than if we traveled to the other locations.

### BRIEF SUMMARY OF THE INVENTION

To minimize the limitations in the prior art, and to minimize other limitations that will be apparent upon reading and understanding the present specification, the present invention provides a mechanism that not only creates the quickest route for a group of people to a common location, but also selects the location for which the individual's longest driving time (between all parties) will be the shortest overall.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a meeting coordinator minimizing joint driving time, as contemplated by the present disclosure.

FIG. 2 illustrates the different routes that can be taken by each vehicle and the optimizer computes the optimal time and route that is best for all vehicles involved

### DETAILED DESCRIPTION OF THE INVENTION

The invention provides tools in different phases: The system is composed of the following components: Localization mechanism for every person (member) that will be part of the meeting; A communication infrastructure that allows a computer to receive the location of every member, and respond with a meeting location (and possibly an optimal route for getting to the meeting location); A road network database that may include traffic, speed limits, and/or road conditions (at the current time, or predicted); A list of possible meeting locations; A user interface that may allow the users to specify their departure times (or it may be assumed to be “now”); A user interface that tells each meeting member where to meet, and possibly the best route there; An optimization mechanism that can find the shortest meeting time among all the possible meeting locations.

An alternative optimization mechanism allows the group to optimize other objective functions that could include a combination of minimum time, fuel/energy, tolls/other transportation costs, wear and tear, etc. These optimization costs could be treated as overall optimization functions, or they could be different for different members of the group. For example, I may be really worried about arriving at a set meeting time, but another

member may be more worried about tolls that need to be paid on the fastest route.

The optimization can also include serving/wait time at the meeting location (such as when a restaurant is overcrowded, and there is a wait time for tables). For example, the optimal site may be IO minutes away; however, the wait time at that site may take one hour. However, a site that is 20 minutes away may not have any wait. In other words, the waiting/serving/processing time of the particular meeting location may also be included as part of the optimization procedure.

In the preferred embodiment of the invention, the system is an app that is available to each member of the desired meeting. The app acquires the location of the member (GPS or other sources), and sends this location to the coordination computer; The app may also request the departure time for each member; Based on this information, the coordination computer optimizes the meeting location and trajectory of everybody in the future meeting, possibly predicting the arrival time or each member and meeting time; The computer then sends to the app (located with the member) the meeting location, meeting time, arrival time, and possibly the optimal trajectory to the meeting location to each member of the meeting; As the members start driving/walking/train/bus/bicycling, the optimizing computer may provide updates to the meeting time, trajectory and ultimately meeting location, if allowed.

There are many algorithms that can be used to optimize the site selection and trajectories. The arrival times of the different members can be considered to be independent from each other; in other words, even though some of the members may be using the same road or the same bus to get there, the addition of an extra person does not significantly affect the overall traffic pattern, and therefore, their arrival times/costs are considered to be independent. Because of this independence assumption, the complexity of the search is linear with respect to the members (or alternatively the number of possible meeting locations), rather than being composed of the full space of search (including all possible member combinations). For example, an A* search can be run, starting at each member's current location, that expands past the last possible meeting location. When these searches are finished, the location that has the shortest arrival time for the last arriving member can be found, and therefore, the site can be selected.

Analogously, the searches can be started at the meeting locations and explained outwards towards each member. The reader should understand that we are not suggesting that the cost of traversing a road forwards and backwards is the same. What we are suggesting is that the search can be run backwards from the meeting locations, while still maintaining the directionality and cost of each edge in the search graph. The advantage of this second approach is that these expansions do not need to be repeated for multiple meetings. For example, if there are multiple parties that are trying to setup a meeting at the XYZ coffee locations, search expansions starting from each of the XYZ locations can be used to optimize both parties without having to recompute for each member of each meeting. [0021] If, on the other hand, the number of locations is very large, and the number of members is very small, then the forwards search will be more computationally efficient.

Other optimization mechanisms are also possible: dynamic programming, integer programming, pheromones-based searches, auctioning/bidding, and genetic algorithms can all be used to optimize or quasi-optimize this problem.

A weight set by the location manager can also be integrated as part of the optimization. For example, XYZ coffee shop may have a new location, and they may want to route more customers in that direction. Therefore, the optimizer can select this preferred location if the travel time is within a certain distance from the optimal solution.

As the members start traversing to the meeting location, the system can re-plan and update.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

This invention involves a system designed to automatically optimize meeting locations for a group of geographically separated members comprising a communication mechanism for transmitting the location of each member to a processor, a processor including a database containing the members of the meeting, a road network and a list of possible locations to meet, an optimization algorithm that computes the location of the meeting to accommodate one or more variety of utility functions (minimum overall time, least fuel, least wear and tear, minimum tolls/fares, minimum time including waiting time at the meeting location).

The system is further comprised of a user interface that tells each member where the meeting location is, what is the meting time, or what is the personal arrival time. In this system, the meeting location could be a restaurant, coffee/tea shop, library, mall, theater, amusement park, company branch or store.

The system could also comprise of a meeting location that is a storage facility or a package exchange facility.

In this system, the database includes traffic, weather, toll, or speed limit information.

In this system, the members can specify a departure time. Also, the members can define preferred meeting time that is used as a soft or hard constraint for the optimizer.

In this system, the optimization algorithm re-optimizes either at a set rate or arbitrary rates. The optimizer uses waiting time at the meeting area as part of the optimization.

In this system, the optimizer can be biased to prefer some locations over others to break a tie between locations that are within a threshold of time (or other costs). Also, the optimizer can be biased to send meetings to locations that are less busy or are more profitable.

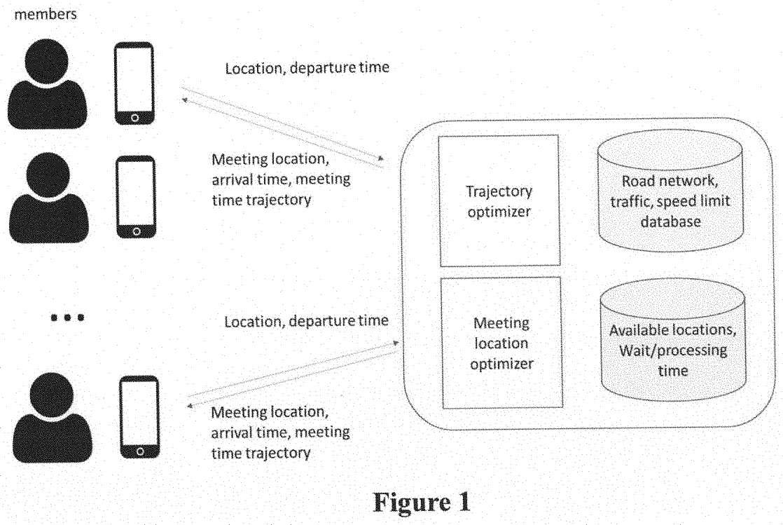

FIG. 1 shows that the trajectory optimizer and meeting location optimizer uses the information in the databases such as the road network, traffic, speed limit database as well as the available locations and wait/processing time as well as the information on the location, departure time, meeting location, arrival time, meting time trajectory to come up with the optimal route for a group of people. This method involves developing an app that can perform this type of meeting coordinator minimizing joint driving time.

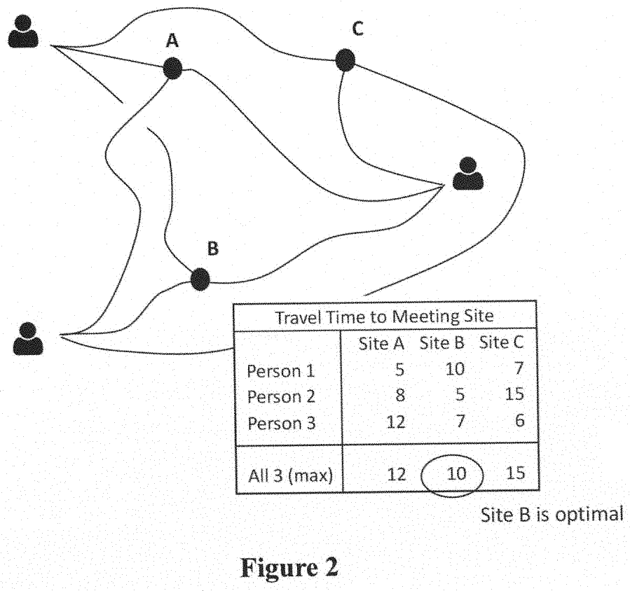

FIG. 2 shows three people and their travel times to three different sites. The optimizer determines the optimum time and site that is suitable for all three people to meet in the quickest time. In this particular case, site B is the optimal site with the lowest amount of time required for everyone to reach the location.

I claim:

1. A system designed to automatically optimize meeting locations for a group of geographically separated members, comprising:
a. A communication mechanism for transmitting the location of each member;
b. A processor including a database containing the members of the meeting, a road network, and a list of possible locations to meet;
c. An optimization algorithm that computes the location of the meeting to accommodate one or more variety of utility functions (minimum overall time, least fuel, least wear and tear, minimum tolls/fares, minimum time including waiting time at the meeting location).

2. The system of claim 1, wherein the system is further comprised of a user interface that tells each member where the meeting location is, the meeting time, or the personal arrival time.

3. The system of claim 1, wherein the meeting location is a restaurant, coffee/tea shop, library, mall, theater, amusement park, company branch, store, or other publicly accessible facility.

4. The system of claim 1, wherein the meeting location is a storage facility or package exchange facility.

5. The system of claim 1, wherein the database includes traffic, weather, toll, or speed limit information.

6. The system of claim 1, wherein the members can specify a departure time.

7. The system of claim 1, wherein the members can define preferred meeting time that is used as a soft or hard constraint for the optimizer.

8. The system of claim 1, wherein the optimization algorithm re-optimizes either at a set rate or arbitrary rates.

9. The system of claim 1, wherein the optimizer uses waiting time at the meeting area as part of the optimization.

10. The system of claim 1, wherein the optimizer can include biased to prefer some locations over others to break a tie between locations that are within a threshold of time (or other costs).

11. The system of claim 1, wherein the optimizer can be biased to send meetings to locations that are less busy, or are more profitable.

12. The system of claim 1, wherein the interface with the member can allow him/her to choose a mode of transportation

13. The system in 1-12, where the interface with the member allows him/her to provide a preferred cost function for optimization.

14. The system in 1-13, where the optimizer uses the cost function provided by the members through their interface.

15. The system in 1-14, where multiple type of meeting places can be suggested by the interface (i.e. coffee shops, malls, restaurants, etc.).

16. The system in 1-15, where the cost of the activity at the meeting area is used by the optimizer.

17. The system in 1-16, where the interface allows the member to specify a preferred cost of the activity at the meeting place. For example, “let's meet at a restaurant, but only choose restaurants that are within a certain price range or food type.”

18. The system in 1-17, where the cost of the location of the meeting can be changed based on different parameters of the optimizer

19. The system on 1-18, where the optimizer gives a list of the top locations and interface allows all members to vote on one of those locations.
